(19) United States
(12) Patent Application Publication
(10) Pub. No.: US 2026/0303272 A1
(43) Pub. Date: Oct. 1, 2026

(54) NON-ORTHOGONAL MULTIPLEXING OF LOW-POWER SIGNALS AND NON-LOW-POWER SIGNALS

(71) Applicant: QUALCOMM Incorporated, San Diego, CA (US)

(72) Inventors: Wei YANG, San Diego, CA (US); Yuchul KIM, San Diego, CA (US); Peter GAAL, San Diego, CA (US); Zhikun WU, Beijing (CN)

(21) Appl. No.: 19/478,146

(22) PCT Filed: May 20, 2023
(86) PCT No.: PCT/CN2023/095411

§ 371 Date: Oct. 23, 2025

(51) Int. Cl. H04L 5/00; H04L 27/04

(52) U.S. Cl. CPC H04L 5/0007; H04L 27/04

(57) ABSTRACT

Various aspects of the present disclosure generally relate to wireless communication. In some aspects, a network node may generate a multiplexed signal based at least in part on a non-orthogonal multiplexing of a low-power signal and a non-low-power signal, wherein information associated with the non-low-power signal is embedded in a sequence used to modulate the low-power signal. The network node may transmit the multiplexed signal. Numerous other aspects are described.

### FIELD OF THE DISCLOSURE

Aspects of the present disclosure generally relate to wireless communication and to techniques and apparatuses for non-orthogonal multiplexing of low-power signals and non-low-power signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a network node includes one or more memories; and one or more processors coupled to the one or more memories, the one or more processors individually or collectively configured to: generate a multiplexed signal based at least in part on a non-orthogonal multiplexing of a low-power signal and a non-low-power signal, wherein information associated with the non-low-power signal is embedded in a sequence used to modulate the low-power signal; and transmit the multiplexed signal.

In some implementations, an apparatus for wireless communication at a UE includes one or more memories; and one or more processors coupled to the one or more memories, the one or more processors individually or collectively configured to: receive one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

In some implementations, a method of wireless communication performed by a network node includes generating a multiplexed signal based at least in part on a non-orthogonal multiplexing of a low-power signal and a non-low-power signal, wherein information associated with the non-low-power signal is embedded in a sequence used to modulate the low-power signal; and transmitting the multiplexed signal.

In some implementations, a method of wireless communication performed by a UE includes receiving one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

In some implementations, a non-transitory computer-readable medium storing a set of instructions for wireless communication includes one or more instructions that, when executed by one or more processors of a network node, cause the network node to: generate a multiplexed signal based at least in part on a non-orthogonal multiplexing of a low-power signal and a non-low-power signal, wherein information associated with the non-low-power signal is embedded in a sequence used to modulate the low-power signal; and transmit the multiplexed signal.

In some implementations, a non-transitory computer-readable medium storing a set of instructions for wireless communication includes one or more instructions that, when executed by one or more processors of a UE, cause the UE to: receive one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

In some implementations, an apparatus for wireless communication includes means for generating a multiplexed signal based at least in part on a non-orthogonal multiplexing of a low-power signal and a non-low-power signal, wherein information associated with the non-low-power signal is embedded in a sequence used to modulate the low-power signal; and means for transmitting the multiplexed signal.

In some implementations, an apparatus for wireless communication includes means for receiving one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an orthogonal frequency division multiplexing (OFDM)-compatible on-off keying (OOK) and frequency-shift keying (FSK) design, in accordance with the present disclosure.

FIG. 5 is a diagram illustrating an example of generating an OFDM-compatible multiple carrier (MC)-OOK and an MC-FSK, in accordance with the present disclosure.

FIG. 6 is a diagram illustrating an example of a low-power wakeup signal (LP-WUS) based at least in part on a time domain OOK with randomized phases, in accordance with the present disclosure.

FIGS. 7-13 are diagrams illustrating examples associated with non-orthogonal multiplexing of low-power signals and non-low-power signals, in accordance with the present disclosure.

FIGS. 14-15 are diagrams illustrating example processes associated with non-orthogonal multiplexing of low-power signals and non-low-power signals, in accordance with the present disclosure.

FIGS. 16-17 are diagrams of example apparatuses for wireless communication, in accordance with the present disclosure.

### DETAILED DESCRIPTION

A low-power wakeup signal (LP-WUS) may be associated with various waveforms, such as on-off keying (OOK) waveforms or frequency-shift keying (FSK) waveforms. However, OOK waveforms and/or FSK waveforms may be associated with various problems. OOK waveforms and/or FSK waveforms may incur a relatively large resource overhead, as compared to an orthogonal frequency division multiplexing (OFDM) waveform. For example, to convey the same amount of wakeup information (e.g., 6 bits) via an OOK/FSK waveform, approximately four times to eight times more time/frequency resources may be needed, as compared to the OFDM waveform. Further, OOK/FSK waveforms may require separate low-power synchronization signals (e.g., based at least in part on the same waveform) to perform a time synchronization for a low-power receiver. The separate low-power synchronization signals may be associated with periodic resources, which a network node may need to commit to in order to support an OOK/FSK based LP-WUS.

Various aspects relate generally to multiplexing a low-power signal and a non-low-power signal. Some aspects more specifically relate to generating a multiplexed signal based at least in part on a non-orthogonal multiplexing of the low-power signal and the non-low-power signal. In some examples, a network node may embed information associated with the non-low-power signal in a sequence (e.g., a phase sequence) used to modulate the low-power signal. The low-power signal may be an OOK or an FSK signal (e.g., an OOK/FSK signal). The low-power signal may be an LP-WUS or a low-power synchronization signal (LP-SS). The non-low-power signal may be an OFDM signal. The network node may transmit the multiplexed signal. The low-power signal may be directed to a user equipment (UE) associated with a low-power receiver. Alternatively, the low-power signal and the non-low-power signal may be directed to a UE associated with a non-low-power receiver. The non-low-power receiver may be associated with an enhanced capability as compared to the low-power receiver, because the non-low-power receiver may be able to receive both the low-power signal and the non-low-power signal, whereas the low-power receiver may only be able to receive the low-power signal.

Particular aspects of the subject matter described in this disclosure can be implemented to realize one or more of the following potential advantages. In some examples, by non-orthogonally multiplexing the low-power signal and the non-low-power signal, the described techniques can be used to improve a spectral efficiency, as compared to when low-power signals are only frequency division multiplexed and/or time division multiplexed with the non-low power signal. The low-power signal may be multiplexed with the non-low-power signal via a superposition (e.g., non-orthogonal multiplexing), which may result in a similar system spectral efficiency as a non-low-power-only system (e.g., an OFDM-only system). At a relatively high signal-to-noise ratio (SNR) for the non-low-power receiver, such an approach may incur an approximately 50% spectral efficiency reduction, as compared to the non-low-power-only system. At a relatively low SNR (e.g., around 0 dB), such an approach may receive a similar spectral efficiency as a legacy non-low-power system (e.g., a legacy OFDM system) (e.g., since a network node may transmit at a same transmit power). As a result, by multiplexing (or super-imposing) non-low-power signals (e.g., OFDM signals) on top of low-power signals (e.g., OOK/FSK signals), an improved resource utilization may be achieved for OOK/FSK based low-power signals (e.g., OOK/FSK based LP-WUSs or LP-SSs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

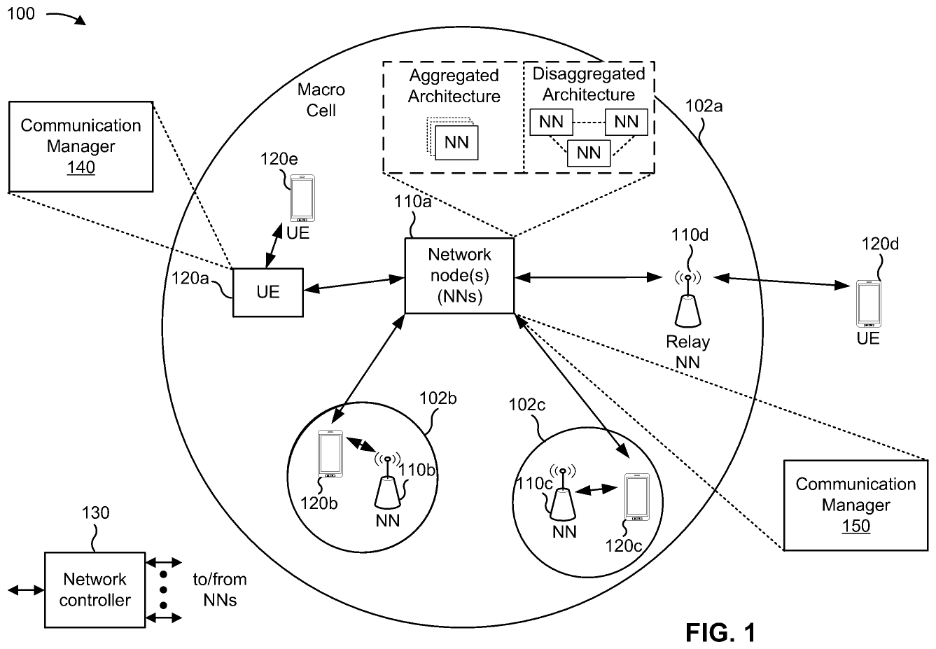

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., the network node 110) may include a communication manager 150. As described in more detail elsewhere herein, the communication manager 150 may generate a multiplexed signal based at least in part on a non-orthogonal multiplexing of a low-power signal and a non-low-power signal, wherein information associated with the non-low-power signal is embedded in a sequence used to modulate the low-power signal; and transmit the multiplexed signal. Additionally, or alternatively, the communication manager 150 may perform one or more other operations described herein.

In some aspects, a UE (e.g., the UE 120) may include a communication manager 140. As described in more detail elsewhere herein, the communication manager 140 may receive one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal. Additionally, or alternatively, the communication manager 140 may perform one or more other operations described herein.

As indicated above, FIG. 1 is provided as an example. Other examples may differ from what is described with regard to FIG. 1.

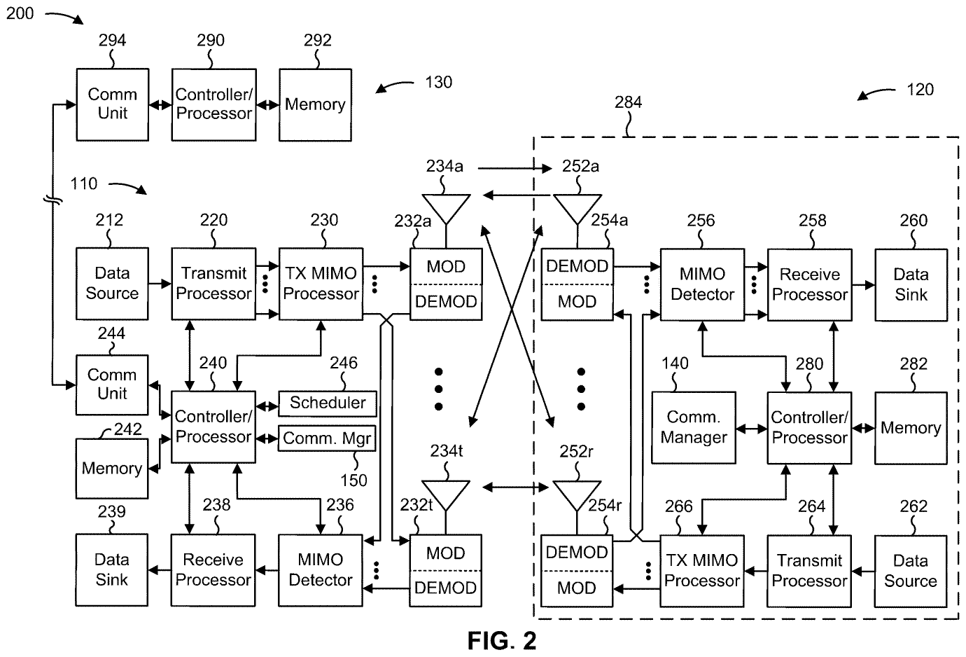

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

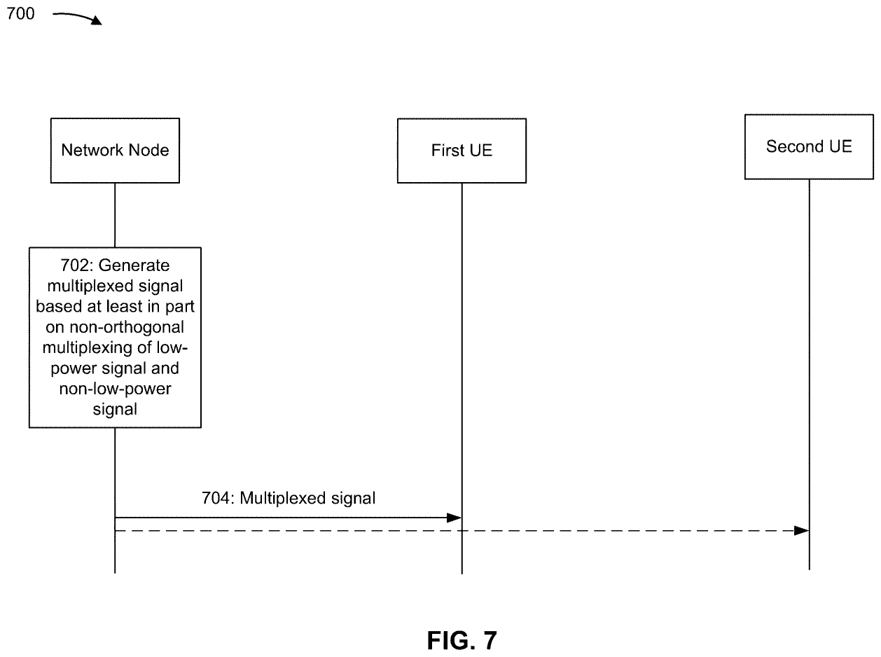

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-17).

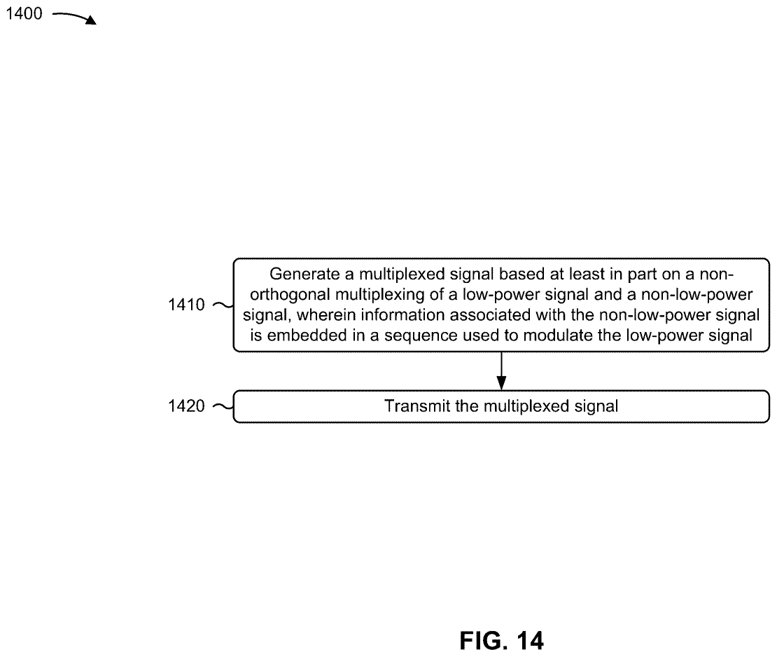

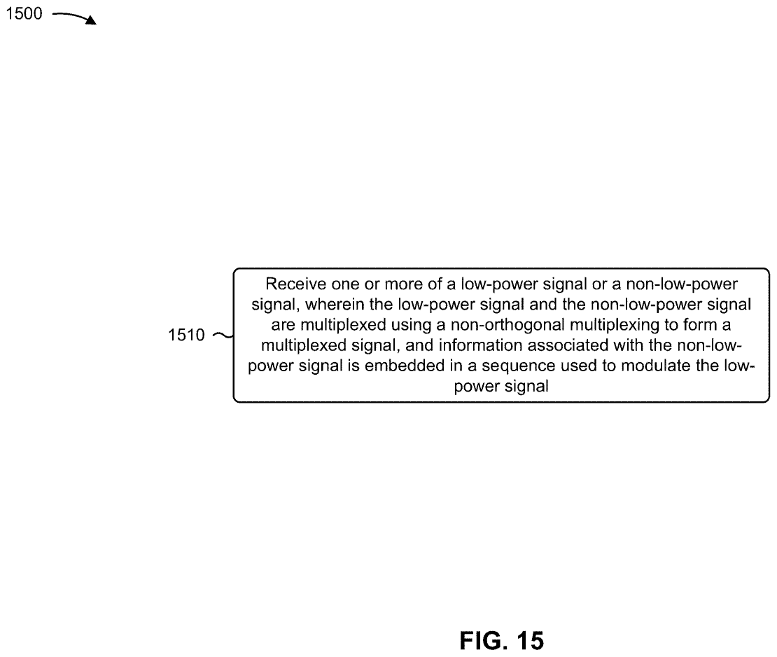

The controller/processor 240 of the network node 110, the controller/processor 280 of the UE 120, and/or any other component(s) of FIG. 2 may perform one or more techniques associated with non-orthogonal multiplexing of low-power signals and non-low-power signals, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a network node (e.g., the network node 110) includes means for generating a multiplexed signal based at least in part on a non-orthogonal multiplexing of a low-power signal and a non-low-power signal, wherein information associated with the non-low-power signal is embedded in a sequence used to modulate the low-power signal; and/or means for transmitting the multiplexed signal. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for receiving one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

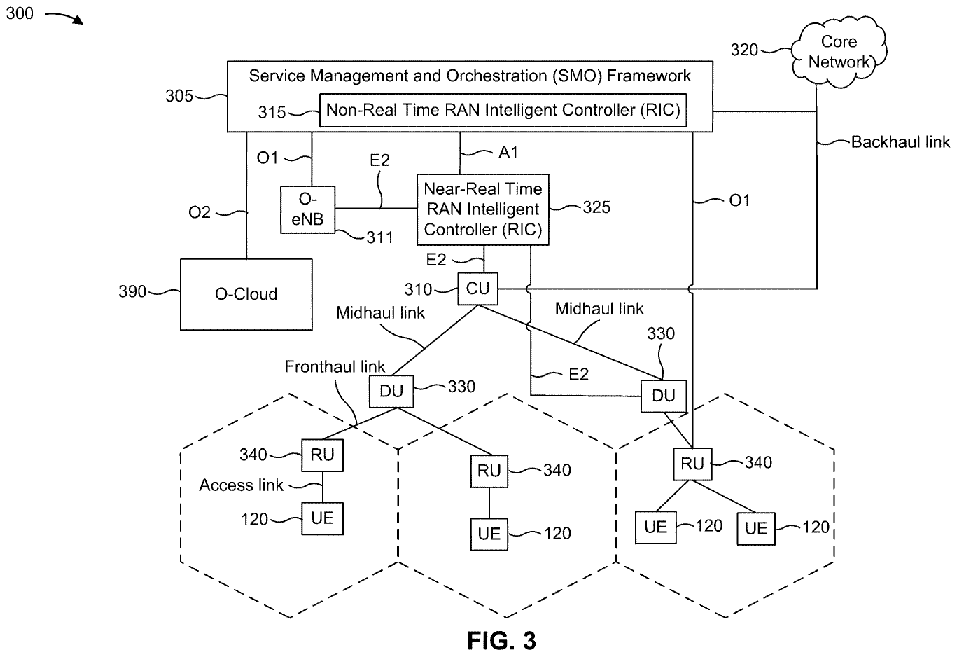

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the Cus 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, Cus 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In an NR system, certain transmission signals/waveforms may be detected by very low-power devices. The very low-power devices may not be able to detect OFDM signals. The very low-power devices may not be able to have an accurate timing/frequency tracking, and/or high sampling rates. The transmission signals/waveforms may be associated with wakeup signals (e.g., LP-WUSs, and/or low-power synchronization signals (LP-SSs)), ambient IoT and/or zero power IoT communications.

An LP-WUS may be associated with various waveforms, such as OOK waveforms or FSK waveforms. However, OOK waveforms and/or FSK waveforms may be associated with various problems. OOK waveforms and/or FSK waveforms may incur a relatively large resource overhead, as compared to an OFDM waveform. For example, to convey the same amount of wakeup information (e.g., 6 bits) via an OOK/FSK waveform, approximately four times to eight times more time/frequency resources may be needed, as compared to the OFDM waveform. Further, OOK/FSK waveforms may require separate LP-SSs (e.g., based at least in part on the same waveform) to perform a time synchronization for a low-power receiver. The separate LP-SS may be associated with periodic resources, which a network node may need to commit to in order to support an OOK/FSK based LP-WUS.

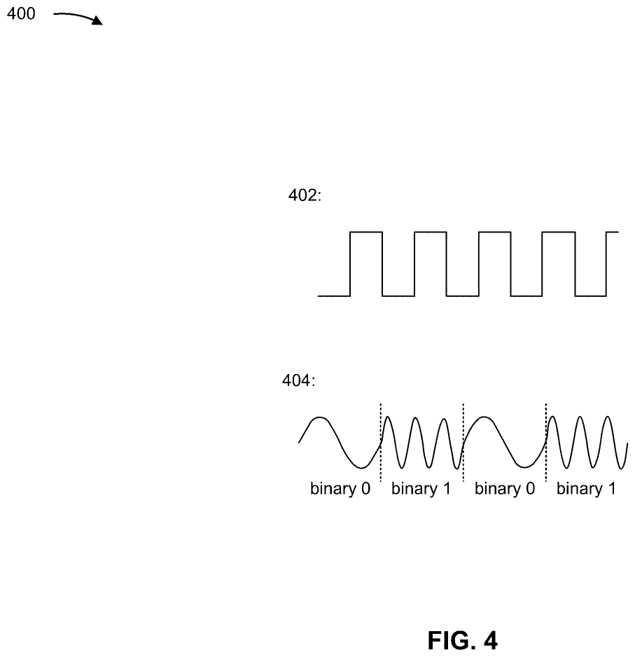

FIG. 4 is a diagram illustrating an example 400 of an OFDM-compatible OOK and FSK design, in accordance with the present disclosure.

As shown by reference number 402, an OFDM-compatible FSK waveform may be associated with an LP-WUS. As shown by reference number 404, an OFDM-compatible OOK waveform may be associated with an LP-WUS.

As indicated above, FIG. 4 is provided as an example. Other examples may differ from what is described with regard to FIG. 4.

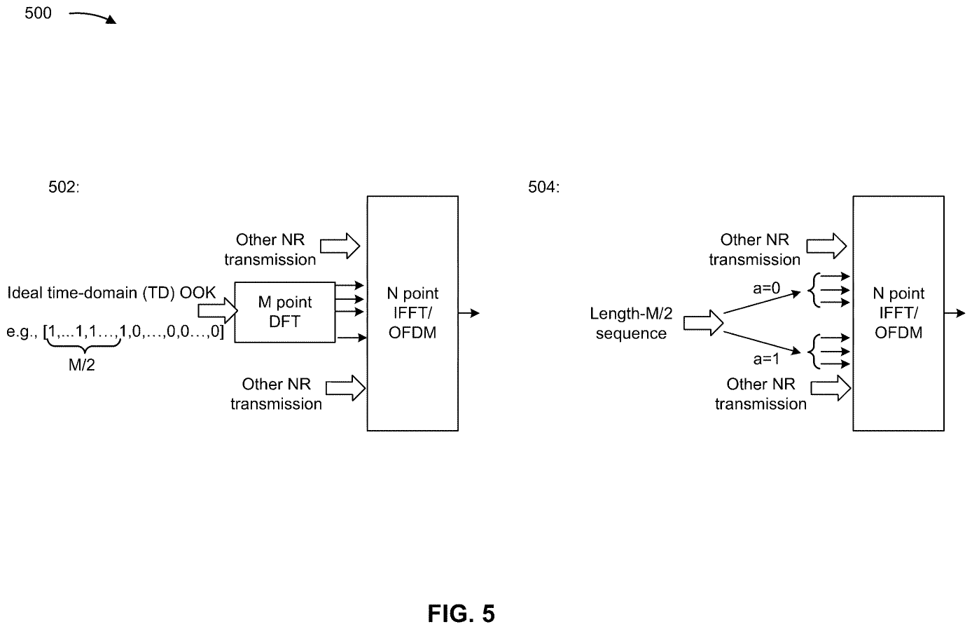

FIG. 5 is a diagram illustrating an example 500 of generating an OFDM-compatible multiple carrier (MC)-OOK and an MC-FSK, in accordance with the present disclosure.

As shown by reference number 502, for an OFDM-compatible MC-OOK, an ideal time-domain OOK may be provided to an M point discrete Fourier transform (DFT), and an output of the M point DFT may be provided to an N point inverse finite Fourier transform (IFFT)/OFDM. Further, other NR transmission(s) may be provided to the N point IFFT/OFDM, and may be multiplexed together with the MC-OOK on different OFDM subcarriers. In this case, the multiplexing between the MC-OOK and the other NR transmissions (e.g., OFDM transmission) may be orthogonal in the frequency domain. An output of the N point IFFT/OFDM may be associated with the OFDM-compatible MC-OOK. As shown by reference number 504, for an OFDM-compatible MC-FSK, a length-M/2 sequence and other NR transmission(s) may be provided to an N point IFFT/OFDM. An output of the N point IFFT/OFDM may be associated with the OFDM-compatible MC-FSK.

As indicated above, FIG. 5 is provided as an example. Other examples may differ from what is described with regard to FIG. 5.

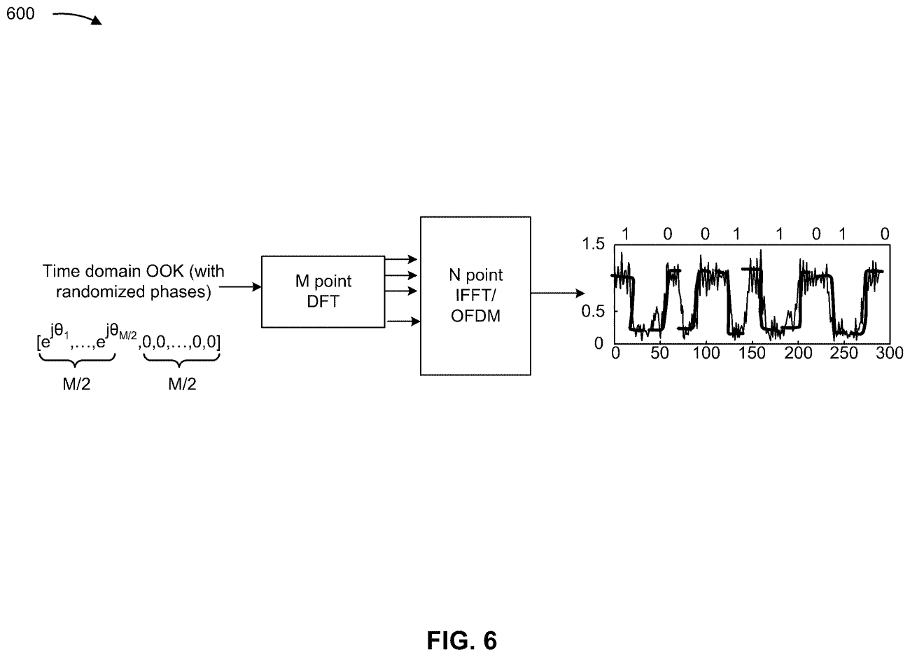

FIG. 6 is a diagram illustrating an example 600 of an LP-WUS based at least in part on a time domain OOK with randomized phases, in accordance with the present disclosure.

As shown in FIG. 6, for an LP-WUS configuration, a time domain OOK with randomized phases may be provided to an M point DFT. Output(s) of the M point DFT may be provided to an N point IFFT/OFDM, which may output an LP-WUS associated with “0” and “1” values.

As indicated above, FIG. 6 is provided as an example. Other examples may differ from what is described with regard to FIG. 6.

In a typical example scenario, an LP-WUS may occupy 4.32 megahertz (MHz) (144 tones at a 30 kHz subcarrier spacing (SCS)) bandwidth, which may be needed to accumulate sufficient energy over a frequency domain, and to make the LP-WUS robust against frequency selective fading. For the frequency selective fading, random phases may be inserted (e.g., in a pre-DFT signal) to modulate an OOK signal. Alternatively, a pre-defined phase sequence (e.g., a Zadoff-Chu sequence or a quadrature phase-shift keying (QPSK) sequence) may be inserted to modulate the OOK signal. Power spectral density (PSD) information associated with the OOK signal may indicate an OOK with random phases in a time domain. A low-power (LP) receiver may ignore a phase of the OOK signal since the lower power receiver may typically use an envelope detector for OOK detection.

An actual data rate of the LP-WUS may be much smaller than a bandwidth consumed. For example, one or two bits per OFDM symbol may correspond to 28 or 56 kilobits per second (kbps) communicated using a 5 MHz bandwidth, which may reflect a resource inefficiency associated with an OOK/FSK based LP-WUS. As another example, to convey the same information at a same SNR, an OOK/FSK signal may typically require 4-8 times more resources as compared to an OFDM based signal. The 4-8 times more resources may be for the same noise figure between an OFDM receiver and a lower power receiver (e.g., an OOK/FSK receiver). When the noise figure of the OFDM receiver is worse than the noise figure of the lower power receiver, even more resources may be needed for OOK/FSK. Thus, OOK waveforms and/or FSK waveforms may incur a relatively large resource overhead (e.g., more time/frequency resources), as compared to an OFDM waveform. The usage of OOK waveforms and/or FSK waveforms may be associated with an inefficient resource utilization (e.g., spectrum efficiency).

In various aspects of techniques and apparatuses described herein, a network node may generate a multiplexed signal based at least in part on a non-orthogonal multiplexing of a low-power signal and a non-low-power signal. The network node may embed information associated with the non-low-power signal in a sequence (e.g., a phase sequence) used to modulate (e.g., generate) the low-power signal. The low-power signal may be an (OFDM-compatible) OOK/FSK signal. OFDM-compatible OOK/FSK signals may be generated using an OFDM transmitter, and may have the same spectrum confinement as a conventional OFDM signal. For example, such signals may be generated by inserting a properly designed (digital) signal on a subset of subcarriers in an OFDM system to emulate/generate the FSK/OOK waveform. The low-power signal may be an LP-WUS or a low-power synchronization signal (LP-SS). The non-low-power signal may be an OFDM signal. The network node may transmit the multiplexed signal. The low-power signal may be directed to a UE associated with a low-power receiver, and the non-low-power signal may be directed to a UE (e.g., a different UE or a same UE) associated with a non-low-power receiver. The non-low-power receiver may be associated with an enhanced capability as compared to the low-power receiver, because the non-low-power receiver may be able to receive both the low-power signal and the non-low-power signal, whereas the low-power receiver may only be able to receive the low-power signal.

In some aspects, when the low-power signal is multiplexed non-orthogonally with the non-low-power signal, a spectral efficiency may be improved, as compared to when low-power signals are only frequency division multiplexed and/or time division multiplexed with the non-low power signal. The low-power signal may be multiplexed with the non-low-power signal via a superposition (e.g., non-orthogonal multiplexing), which may result in a similar system spectral efficiency as a non-low-power-only system (e.g., an OFDM-only system). At a relatively high SNR for the non-low-power receiver, such an approach may incur an approximately 50% spectral efficiency reduction, as compared to the non-low-power-only system. At a relatively low SNR (e.g., around 0 dB), such an approach may receive a similar spectral efficiency as a legacy non-low-power system (e.g., a legacy OFDM system) (e.g., since a network node may transmit at a same transmit power). As a result, by multiplexing (or super-imposing, or embedding) non-low-power signals (e.g., OFDM signals) on top of low-power signals (e.g., OOK/FSK signals), an improved resource utilization may be achieved for OOK/FSK based low-power signals (e.g., OOK/FSK based LP-WUSs or LP-SSs).

FIG. 7 is a diagram illustrating an example 700 associated with non-orthogonal multiplexing of low-power signals and non-low-power signals, in accordance with the present disclosure. As shown in FIG. 7, example 700 includes communication between a network node (e.g., network node 110), a first UE (e.g., UE 120a), and/or a second UE (e.g., UE 120e). In some aspects, the network node, the first UE, and/or the second UE may be included in a wireless network, such as wireless network 100.

In some aspects, the first UE may be associated with a low-power receiver (e.g., an OOK/FSK receiver) and/or a non-low-power receiver (e.g., an OFDM receiver). The second UE may be associated with a low-power receiver and/or a non-low-power receiver. A low-power receiver may be associated with a lower capability as compared with a non-low-power receiver.

As shown by reference number 702, the network node may generate a multiplexed signal based at least in part on a non-orthogonal multiplexing of a low-power signal and a non-low-power signal. The low-power signal may be an OOK/FSK signal. The non-low-power signal may be an OFDM signal. For example, the non-low-power signal may be a DFT-s-OFDM signal, which may be viewed as a special form of OFDM. The network node may embed information associated with the non-low-power signal in a sequence used to modulate the low-power signal. For example, the sequence may be a phase sequence, and the information for the non-low-power signal may be embedded in phases of the phase sequence. The low-power signal may be directed to the first UE or the second UE, which may be associated with the low-power receiver. In other words, the low-power receiver may be capable of detecting the low-power signal. Alternatively, the low-power signal and the non-low-power signal may be directed to the first UE or the second UE, which may be associated with the non-low-power receiver. In other words, the non-low-power receiver may be capable of detecting both the low-power signal and the non-low-power signal.

In some aspects, the low-power signal may be associated with one bit and the non-low-power signal may be associated with a plurality of bits. The low-power signal may be directed to the first UE, which may be associated with the low-power receiver. The non-low-power signal may be directed to the second UE, which may be associated with the non-low-power receiver.

In some aspects, the network node may embed (e.g., multiplex) the OFDM signal in the OOK/FSK signal. The OFDM signal may be multiplexed or super-imposed on top of the OOK/FSK signal on the same time/frequency resources. The OFDM signal may be multiplexed non-orthogonally with the OOK/FSK signal. In some aspects, the OFDM signal may be associated with the information, which may be in the sequence (e.g., the phase sequence) used to modulate the OOK/FSK signal. The information may be targeted to only an OFDM receiver (e.g., not an OOK/FSK receiver).

In some aspects, the OOK/FSK receiver may ignore the sequence, and may rely on an envelope detector to perform an on-off/frequency offset detection. Since the OOK/FSK receiver may ignore the sequence, the OOK/FSK receiver may only detect the OOK/FSK signal, and may not detect the information in the sequence. In some aspects, the OFDM receiver may detect both the OOK/FSK signal and the OFDM signal. The OFDM receiver may detect the sequence, which may allow the OFDM receiver to retrieve the information contained in the sequence.

In some aspects, when the OOK/FSK signal is multiplexed non-orthogonally with the OFDM signal, a spectral efficiency may be improved, as compared to when OOK/FSK signals are only frequency division multiplexed and/or time division multiplexed with the non-low power signal. The OOK/FSK signal may be multiplexed with the OFDM signal via a superposition (e.g., non-orthogonal multiplexing), which may result in a similar system spectral efficiency as an OFDM-only system.

In some aspects, the low-power signal may be directed to the first UE and the non-low-power signal may be directed to the second UE. Alternatively, the low-power signal and the non-low-power signal may be directed to the first UE or the second UE.

In some aspects, the OOK/FSK signal and the OFDM signal (e.g., a phase signal) may be intended for different receivers (e.g., different UEs). In some aspects, the OOK/FSK signal and the OFDM signal may be conveyed to a single receiver (e.g., the same UE). When the first UE or the second UE only turns on/implements the OOK/FSK receiver, the first UE or the second UE may only decode the OOK/FSK signal. When the first UE or the second UE turns on/implements the OFDM receiver, the first UE or the second UE may be able to receive both the OOK/FSK signal (e.g., information contained in OOK/FSK) and the OFDM signal (e.g., information contained in the phase signal).

In some aspects, the low-power signal may be an LP-SS and the non-low-power signal may be associated with system information. The system information may include a master information block (MIB), a system information block (SIB), or a physical broadcast channel (PBCH). In some aspects, the multiplexing of the OOK/FSK signal and the OFDM signal may be associated with various use cases. A first use case may involve multiplexing the LP-SS and other system information. The network node may convey/embed some system information over the LP-SS. The system information may include the MIB, the SIB, and/or the PBCH. The OOK/FSK receiver may use the LP-SS to perform a time and/or a frequency synchronization. The OFDM receiver may receive the system information via the OFDM signal. A signal used for the LP-SS may be pre-configured to the OFDM receiver. The OFDM receiver may not need to perform blind detection on the OOK/FSK signal.

In some aspects, the low-power signal may be an LP-WUS containing a wakeup indication to a group of UEs, and the non-low power signal may contain wakeup information for each UE, or each subgroup of UEs in the group of UEs. For example, the LP-WUS may contain 1 bit indicating whether a group of UEs need to be woken up. In this case, when any of the UEs in the group of UEs need to be woken up, the network node may have to transmit the 1-bit wakeup indication to all UEs in the group of UEs, due to the limited amount of information that can be carried in the LP-WUS. However, the network node may signal additional information about an identity of a specific UE, or an identity of a subgroup of UEs in the group of UEs that need to wake up using the non-low-power signal. In this case, when the first UE or the second UE turns on the non-low-power receiver (e.g., a more capable receiver), the first UE or the second UE may be able to know which UE/subgroup of UEs in the group of UEs needs to wake up. In this case, when the wakeup indication is not intended for this UE/subgroup of UEs, then the first UE or the second UE may go back to sleep. In contrast, when the first UE or the second UE does not have the capability to receive the non-low-power signal, the first UE or the second UE may need to wake up, as long as any UE in the group of UEs needs to receive some information from the network node.

In some aspects, the first UE or the second UE may decide whether to use the low-power receiver and whether to use a lower power, but suffer from a higher false wakeup probability (e.g., which may occur when the LP-WUS is not intended for the first UE or the second UE). The first UE or the second UE may decide whether to use the non-low-power receiver, receive more information (e.g., contained in both the low-power signal, and the non-low-power signal), and spend more power to receive this information, but also reduce a false wakeup probability.

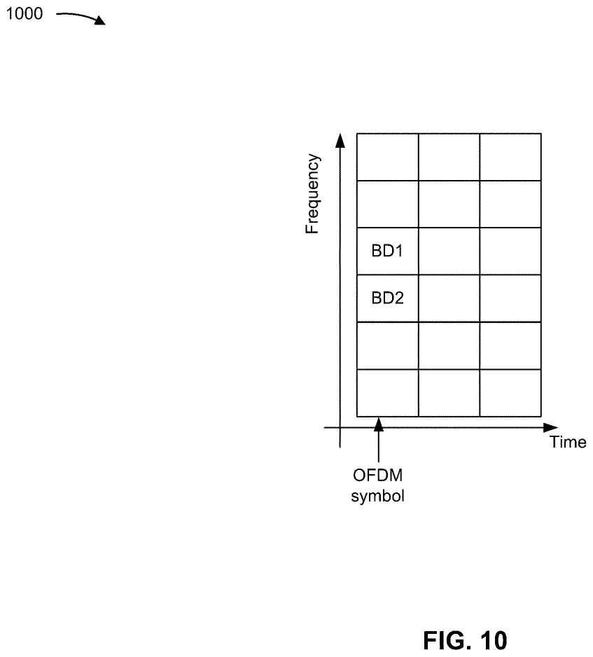

In some aspects, the low-power signal may be an LP-WUS or an LP-SS with FSK, and the non-low-power signal may be associated with a physical downlink control channel (PDCCH) transmission. FSK information may be conveyed in the low-power signal by placing a PDCCH candidate in a frequency region associated with an FSK modulation. In some aspects, a second use case may involve embedding a legacy PDCCH transmission in the LP-WUS/LP-SS with FSK. The network node may configure different blind detection candidates to the OFDM receiver. Each blind detection candidate may occupy x control channel elements (CCEs) (e.g., a CCE equals 6 resource blocks (RBs)) in 1 OFDM symbol at different RBs. The network node may convey the FSK information by placing the PDCCH candidate in a first blind detection region or a second blind detection region (e.g., as shown in FIG. 10). The first blind detection region may be associated with a first frequency region, and the second blind detection region may be associated with a second frequency region. The FSK receiver may need to detect whether energy is contained in the first blind detection region or the second blind detection region to detect the information bit contained in the FSK (e.g., low-power) signal. As an example, a total bandwidth for the LP-WUS may be 12 RB=4.32 MHz (e.g., at a 30 kHz SCS), and each PDCCH candidate may consume 1 CCE (e.g., with an aggregation level of 1). The OFDM receiver may perform a PDCCH blind detection to determine whether the first blind detection region or the second blind detection region is used. Such an approach may be used to convey information/PDCCH to a legacy OFDM UE. The legacy OFDM UE may not need to know whether a signal is a pure PDCCH transmission, or whether the signal is a multiplexed transmission between a PDCCH and the LP-WUS/LP-SS.

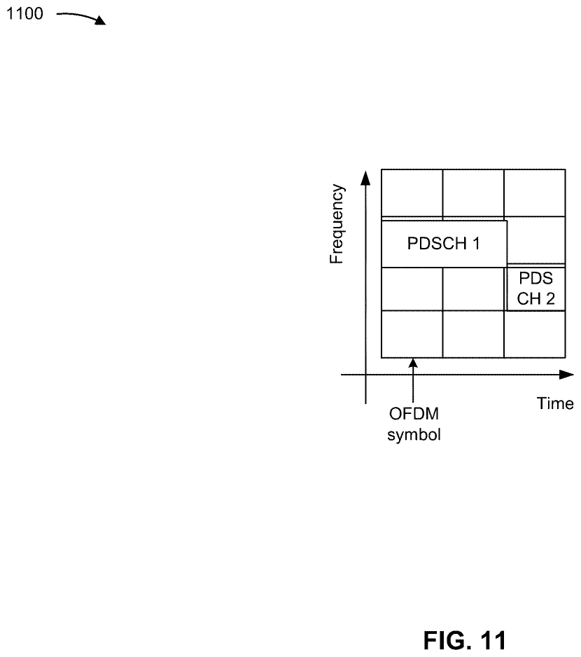

In some aspects, the low-power signal may be an LP-WUS or an LP-SS with FSK, and the non-low-power signal may be associated with a physical downlink shared channel (PDSCH) transmission. In some aspects, a third use case may involve embedding a legacy PDSCH transmission in the LP-WUS/LP-SS with FSK. The network node may need to transmit 3 FSK bits (e.g., 0, 0, and 1) in 3 OFDM symbols. The network node may be able to use first resources to transmit a first PDSCH to a first OFDM receiver on OFDM symbols 1 and 2, and the network node may be able to use second resources to transmit a second PDSCH to a second OFDM receiver on OFDM symbol 3 (e.g., as shown in FIG. 11). In this case, the network node may dynamically indicate the PDSCH locations (e.g., OFDM symbol/RB locations) to the two OFDM receivers, so that the two OFDM receivers do not need to perform any blind detection.

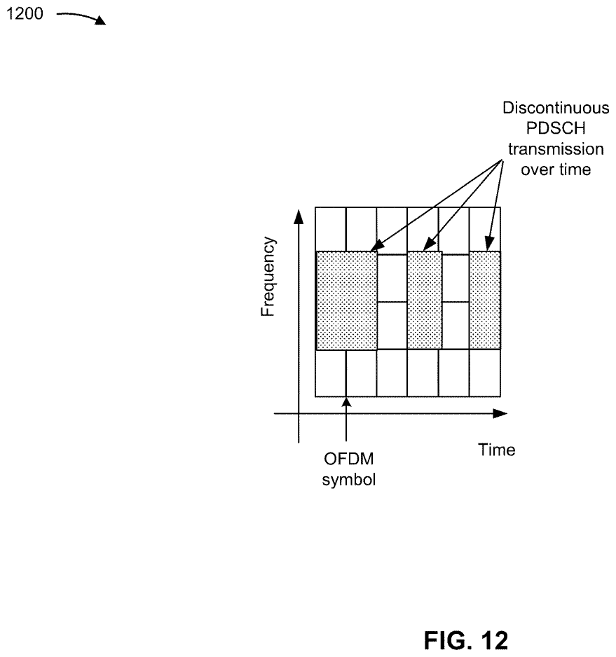

In some aspects, the low-power signal may be an LP-WUS or an LP-SS with OOK, the non-low-power signal may be associated with a PDSCH transmission, and the PDSCH transmission may be transmitted based at least in part on an ON duration associated with the low-power signal. In some aspects, a fourth use case may involve embedding the PDSCH transmission in the LP-WUS/LP-SS with OOK (e.g., for new OOK aware UEs). The network node may use ON durations of the OOK signal to transmit the PDSCH to the OFDM receiver (e.g., as shown in FIG. 12). In this case, the network node may optionally indicate the ON locations (e.g., OOK bits) to the OFDM receiver (e.g., in a separate control transmission). For example, OFDM symbols 1, 2, 4, and 6 may be ON, and may be used to transmit signals to the OFDM receiver. The network node may properly select an MCS of the PDSCH transmission, such that the OFDM receiver is able to correctly decode packets using only the signals conveyed in the ON portions.

As shown by reference number 704, the network node may transmit the multiplexed signal, which may be based at least in part on the non-orthogonal multiplexing of the low-power signal and the non-low-power signal. In some aspects, the multiplexed signal may be received by the first UE and/or the second UE. In this case, the first UE and/or the second UE may receive both the low-power signal and the non-low-power signal, depending on a receiver capability of the first UE and/or the second UE. In some aspects, only the low-power signal may be received by the first UE and/or the second UE, depending on the receiver capability of the first UE and/or the second UE. In some aspects, the low-power signal may be received by the first UE, and the non-low-power signal may be received by the second UE, or vice versa, which may be based at least in part on the transmission of the multiplexed signal by the network node.

As indicated above, FIG. 7 is provided as an example. Other examples may differ from what is described with regard to FIG. 7.

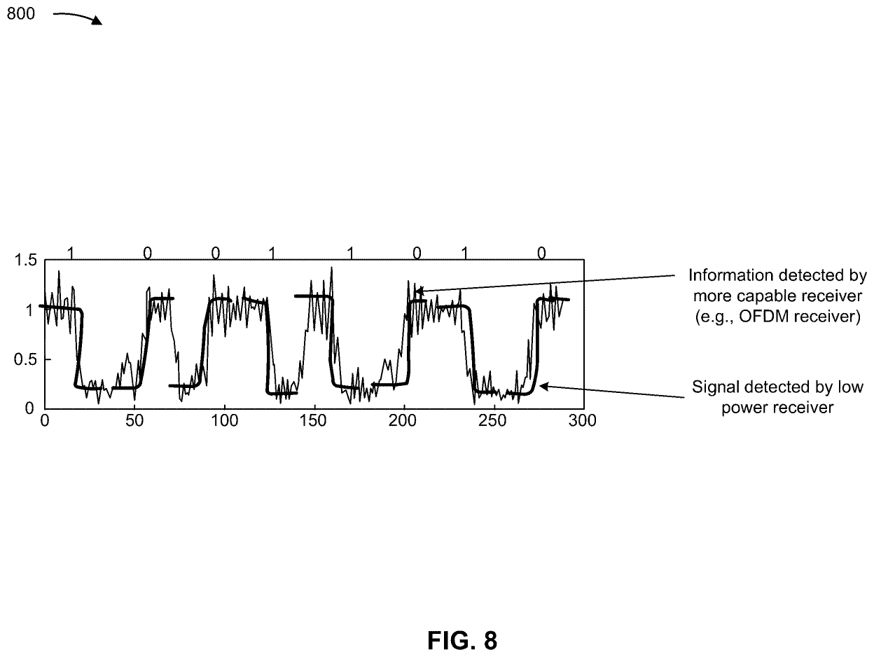

FIG. 8 is a diagram illustrating an example 800 associated with non-orthogonal multiplexing of low-power signals and non-low-power signals, in accordance with the present disclosure.

As shown in FIG. 8, an OFDM signal may be multiplexed with an OOK/FSK signal. The OFDM signal may be associated with information that is inside of a sequence (e.g., a phase sequence) used to modulate the OOK/FSK signal. The OFDM signal may be detected by a more capable receiver (e.g., an OFDM receiver). The OOK/FSK signal may be detected by both an LP receiver and the more capable receiver. The OFDM signal may not be detected by the LP receiver.

As indicated above, FIG. 8 is provided as an example. Other examples may differ from what is described with regard to FIG. 8.

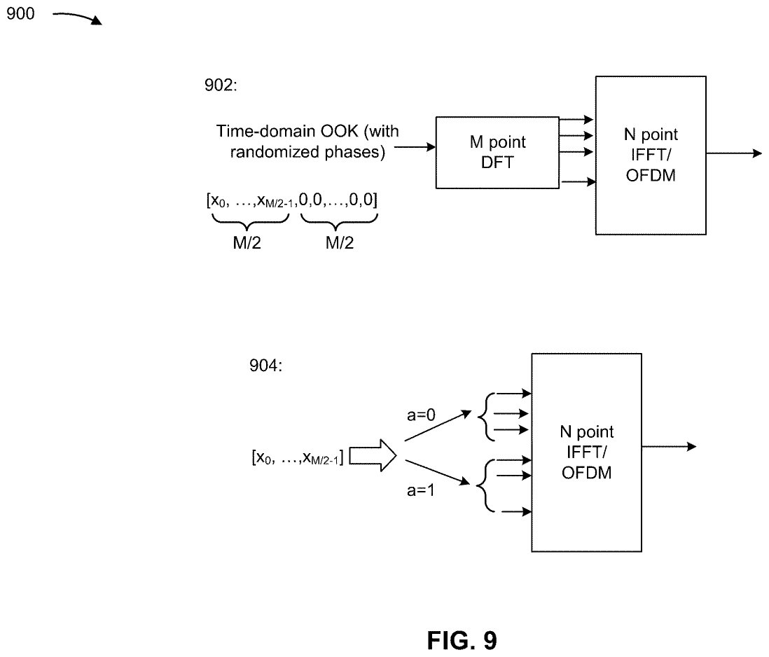

FIG. 9 is a diagram illustrating an example 900 associated with non-orthogonal multiplexing of low-power signals and non-low-power signals, in accordance with the present disclosure.

In some aspects, a network node may have 1 bit information (denoted by a) to transmit to the OOK/FSK receiver. The OOK/FSK receiver may be associated with a first UE. The network node may have M bits of information to transmit to the OFDM receiver. The OFDM receiver may be associated with a second UE. The network node may modulate the Mbits using QPSK to generate M/2 QPSK symbols, which may be denoted by

$${x}_{0} , … , {x}_{\frac{M}{2} - 1} .$$

As shown by reference number 902, for a superimposition via OOK, in order to transmit such a signal to both the first UE and the second UE, the network node may, when a=0, transmit

$$[ {x}_{0} , … , {x}_{\frac{M}{2} - 1} , 0 … , 0 ]$$

on M subcarriers using an M point DFT. For OOK, in order to transmit the signal to both the first UE and the second UE, the network node may, when a=1, transmit

$$[ 0 … , 0 , {x}_{0} , … , {x}_{\frac{M}{2} - 1} ]$$

on the same M subcarriers using an M point DFT. An output of the M point DFT may be an input to an N point IFFT/OFDM. The first UE may detect whether energy is contained in a first half or a second half of an OFDM symbol to detect a. The second UE may first detect a, and after detecting a, the second UE may further decode

$${x}_{0} , … , {x}_{\frac{M}{2} - 1}$$

via a DFT-S-OFDM demodulator.

As shown by reference number 904, for a superimposition via FSK, the network node may place the QPSK modulated symbols x₀, . . . , x_{M/2-1} at subcarriers 0 to M/2−1 when a=0, and place the symbols x₀, . . . , x_{M/2-1} on the rest of the subcarriers (e.g., subcarriers M/2, . . . , M−1) when a=1. Inputs related to a=0 and a=1 may be provided to an N point IFFT/OFDM. The first UE may detect whether energy is contained in a first half or a second half of frequency domain resources. The second UE may first detect a, and after detecting a, the second UE may further decode x₀, . . . , x_{M/2-1} in a frequency domain via an OFDM demodulator.

As indicated above, FIG. 9 is provided as an example. Other examples may differ from what is described with regard to FIG. 9.

FIG. 10 is a diagram illustrating an example 1000 associated with non-orthogonal multiplexing of low-power signals and non-low-power signals, in accordance with the present disclosure.

In some aspects, a (legacy) PDCCH transmission may be embedded in an LP-WUS/LP-SS with FSK. A network node may configure different blind detection candidates to an OFDM receiver. Each blind detection candidate may occupy x CCEs in 1 OFDM symbol at different RBs. The network node may convey FSK information by placing a PDCCH candidate in a first blind detection region or a second blind detection region (as shown in FIG. 10). The first blind detection region may be associated with a first frequency region, and the second blind detection region may be associated with a second frequency region. An FSK receiver may need to detect whether energy is contained in the first blind detection region or the second blind detection region to detect a bit. An OFDM receiver may perform a PDCCH blind detection to determine whether the first blind detection region or the second blind detection region is used.

As indicated above, FIG. 10 is provided as an example. Other examples may differ from what is described with regard to FIG. 10.

FIG. 11 is a diagram illustrating an example 1100 associated with non-orthogonal multiplexing of low-power signals and non-low-power signals, in accordance with the present disclosure.

As shown in FIG. 11, a legacy PDSCH transmission may be embedded in an LP-WUS/LP-SS with FSK. A network node may need to transmit 3 FSK bits (e.g., 0, 0, and 1) in 3 OFDM symbols. The network node may be able to use first resources to transmit a first PDSCH to a first OFDM receiver on OFDM symbols 1 and 2, and the network node may be able to use second resources to transmit a second PDSCH to a second OFDM receiver on OFDM symbol 3. In this case, the network node may dynamically indicate the PDSCH locations (e.g., OFDM symbol/RB locations) to the two OFDM receivers, so that the two OFDM receivers do not need to perform any blind detection.

As indicated above, FIG. 11 is provided as an example. Other examples may differ from what is described with regard to FIG. 11.

FIG. 12 is a diagram illustrating an example 1200 associated with non-orthogonal multiplexing of low-power signals and non-low-power signals, in accordance with the present disclosure.

As shown in FIG. 12, a PDSCH transmission may be embedded in an LP-WUS/LP-SS with OOK. A network node may use ON durations of an OOK signal to transmit the PDSCH to an OFDM receiver. In this case, the network node may optionally indicate the ON locations (e.g., OOK bits) to the OFDM receiver (e.g., in a separate control transmission). For example, OFDM symbols 1, 2, 4, and 6 may be ON, and may be used to transmit signals to the OFDM receiver. The network node may properly select an MCS of the PDSCH transmission, such that the OFDM receiver is able to correctly decode packets using only the signals conveyed in the ON portions.

As indicated above, FIG. 12 is provided as an example. Other examples may differ from what is described with regard to FIG. 12.

In some aspects, for an FSK transmission, overall resources used to convey information to an OFDM receiver may be constant, because regardless of the FSK information to be transmitted, a network node may transmit an FSK signal over half of the frequency resources. In contrast, for an OOK transmission, an OOK signal may be OFF or ON (e.g., all OFF or all ON), depending on the OOK information to be transmitted, which may be problematic for the OFDM receiver. The OFDM receiver may have no guarantee that a certain portion of the OOK signal will be OFF or ON. In a worst-case scenario, when the OOK signal is all OFF, no additional information may be transmitted to the OFDM receiver.

In some aspects, to address this issue, the OOK signal may be designed such that a guaranteed portion of ON and OFF durations is in the OOK signal. The OOK signal may be associated with guaranteed portions for the ON and OFF durations. The guaranteed portions may include a 50% portion (or approximately a 50% portion) for the ON duration and a 50% portion (or approximately a 50% portion) for the OFF duration. A coding (e.g., Manchester coding) may be used to encode each OOK bit. In this approach, bit 0 may be represented by ON-OFF, and bit 1 may be represented by OFF-ON. That is, information may be conveyed through the transition of ON/OFF signals, instead of the ON/OFF levels themselves. The approach may be generalized via proper coding, such that for a sequence of transmissions of length N (e.g., a₀, . . . , a_{N-1}), half of the bits may be 0, and half of the bits may be 1, which may be due to P=0.5 maximizing an entropy of a binary random variable (H_{b} (0.5)=1). P is a design parameter for the scheme, and when P>0.5, more ones (is) in the OOK transmission may be available for use to convey information to the OFDM receiver.

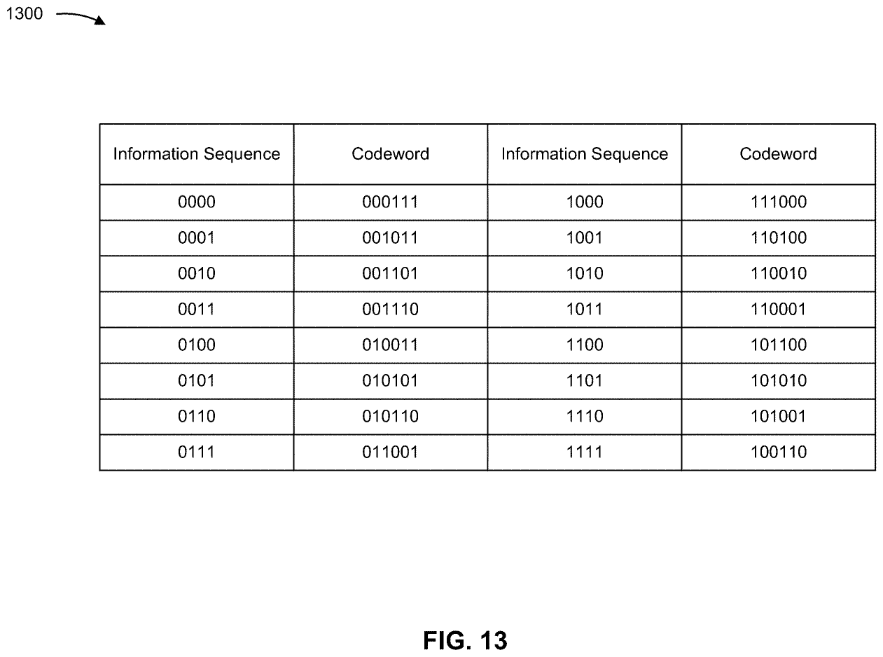

FIG. 13 is a diagram illustrating an example 1300 associated with non-orthogonal multiplexing of low-power signals and non-low-power signals, in accordance with the present disclosure.

As shown in FIG. 13, 4 bits may be encoded into a codeword of length 6, such that every codeword may have exactly 3 zeros and 3 ones. With a length-2m codeword,

$${log}_{2} ( \begin{matrix}2 m \\ m\end{matrix} )$$

bits may be conveyed. The code rate

$$R = {log}_{2} ( \begin{matrix}2 m \\ m\end{matrix} ) / 2 m$$

may converge to 1 as m goes to infinity (e.g., by a simple typicality argument).

As indicated above, FIG. 13 is provided as an example. Other examples may differ from what is described with regard to FIG. 13.

FIG. 14 is a diagram illustrating an example process 1400 performed, for example, by a network node, in accordance with the present disclosure. Example process 1400 is an example where the network node (e.g., network node 110) performs operations associated with non-orthogonal multiplexing of low-power signals and non-low-power signals.

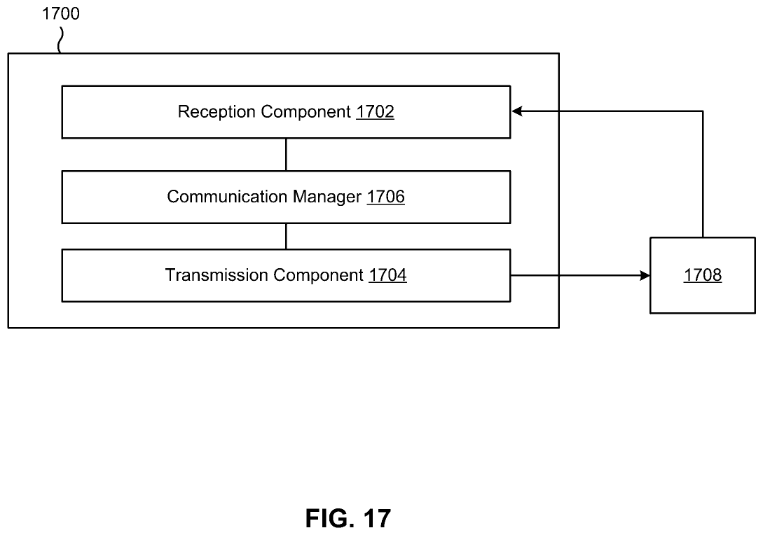

As shown in FIG. 14, in some aspects, process 1400 may include generating a multiplexed signal based at least in part on a non-orthogonal multiplexing of a low-power signal and a non-low-power signal, wherein information associated with the non-low-power signal is embedded in a sequence used to modulate the low-power signal (block 1410). For example, the network node (e.g., using communication manager 1706, depicted in FIG. 17) may generate a multiplexed signal based at least in part on a non-orthogonal multiplexing of a low-power signal and a non-low-power signal, wherein information associated with the non-low-power signal is embedded in a sequence used to modulate the low-power signal, as described above.

As further shown in FIG. 14, in some aspects, process 1400 may include transmitting the multiplexed signal (block 1420). For example, the network node (e.g., using transmission component 1704 and/or communication manager 1706, depicted in FIG. 17) may transmit the multiplexed signal, as described above.

Process 1400 may include additional aspects, such as any single aspect or any combination of aspects described below and/or in connection with one or more other processes described elsewhere herein.

In a first aspect, the low-power signal is an OOK signal or an FSK signal, and the non-low-power signal is an OFDM signal.

In a second aspect, alone or in combination with the first aspect, the low-power signal is directed to a UE associated with a low-power receiver, or the low-power signal and the non-low-power signal are directed to a UE associated with a non-low-power receiver.

In a third aspect, alone or in combination with one or more of the first and second aspects, the low-power signal is associated with one bit and the non-low-power signal is associated with a plurality of bits, and the low-power signal is directed to a first UE associated with a low-power receiver and the non-low-power signal is directed to a second UE associated with a non-low-power receiver.

In a fourth aspect, alone or in combination with one or more of the first through third aspects, the low-power signal is directed to a first UE and the non-low-power signal is directed to a second UE, or the low-power signal and the non-low-power signal are directed to the first UE.

In a fifth aspect, alone or in combination with one or more of the first through fourth aspects, the low-power signal is an LP-SS and the non-low-power signal is associated with system information, and the system information includes one of a MIB, a SIB, or a PBCH.

In a sixth aspect, alone or in combination with one or more of the first through fifth aspects, the low-power signal is an LP-WUS or an LP-SS with FSK, and the non-low-power signal is associated with a PDCCH transmission, and FSK information is conveyed in the low-power signal by placing a PDCCH candidate in a frequency region associated with an FSK modulation.

In a seventh aspect, alone or in combination with one or more of the first through sixth aspects, the low-power signal is an LP-WUS or an LP-SS with FSK, the non-low-power signal is associated with a PDSCH transmission, and a frequency allocation associated with PDSCH locations is signaled to a UE associated with a non-low-power receiver.

In an eighth aspect, alone or in combination with one or more of the first through seventh aspects, the low-power signal is an LP-WUS or an LP-SS with OOK, the non-low-power signal is associated with a PDSCH transmission, and the PDSCH transmission is transmitted based at least in part on an ON duration associated with the low-power signal.

In a ninth aspect, alone or in combination with one or more of the first through eighth aspects, the low-power signal is an OOK signal, the OOK signal is associated with guaranteed portions for an ON duration and an OFF duration, and the guaranteed portions include a 50% portion for the ON duration and a 50% portion for the OFF duration.

In a tenth aspect, alone or in combination with one or more of the first through ninth aspects, the low-power signal is an LP-WUS including a wakeup indication to a group of UEs, and the non-low-power signal includes wakeup information for each UE, or each subgroup of UEs, in the group of UEs.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120) performs operations associated with non-orthogonal multiplexing of low-power signals and non-low-power signals.

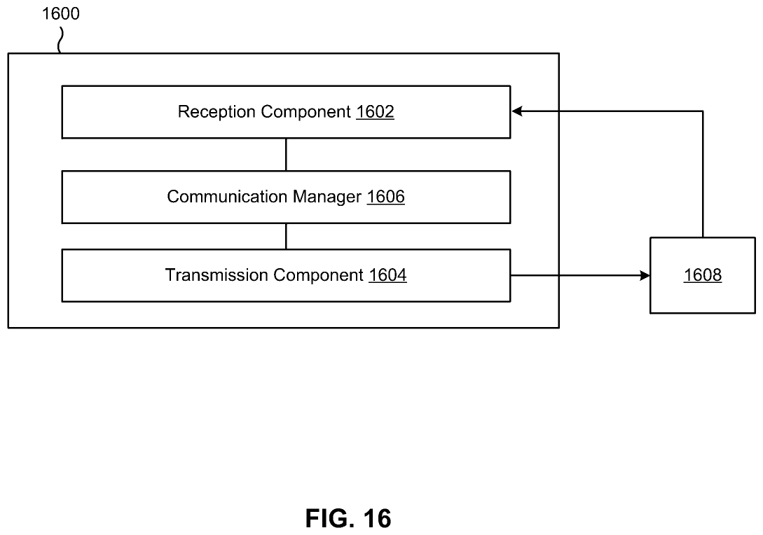

As shown in FIG. 15, in some aspects, process 1500 may include receiving one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal (block 1510). For example, the UE (e.g., using reception component 1602 and/or communication manager 1606, depicted in FIG. 16) may receive one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal, as described above.

Process 1500 may include additional aspects, such as any single aspect or any combination of aspects described below and/or in connection with one or more other processes described elsewhere herein.

In a first aspect, the low-power signal is an OOK signal or an FSK signal, and the non-low-power signal is an OFDM signal.

In a second aspect, alone or in combination with the first aspect, the UE is associated with a low-power receiver, and the low-power signal is detectable by the UE, or the UE is associated with a non-low-power receiver, and the low-power signal and the non-low-power signal are detectable by the UE.

In a third aspect, alone or in combination with one or more of the first and second aspects, the UE is a first UE, the low-power signal is associated with one bit and the non-low-power signal is associated with a plurality of bits, and the low-power signal is directed to the first UE associated with a low-power receiver and the non-low-power signal is directed to a second UE associated with a non-low-power receiver.

In a fourth aspect, alone or in combination with one or more of the first through third aspects, the UE is a first UE, and the low-power signal is directed to the first UE and the non-low-power signal is directed to a second UE, or the low-power signal and the non-low-power signal are directed to the first UE.

In a fifth aspect, alone or in combination with one or more of the first through fourth aspects, the low-power signal is an LP-SS and the non-low-power signal is associated with system information, and the system information includes one of a MIB, a SIB, or a PBCH.

In a sixth aspect, alone or in combination with one or more of the first through fifth aspects, the low-power signal is an LP-WUS or an LP-SS with FSK, and the non-low-power signal is associated with a PDCCH transmission, and FSK information is conveyed in the low-power signal by placing a PDCCH candidate in a frequency region associated with an FSK modulation.

In a seventh aspect, alone or in combination with one or more of the first through sixth aspects, the low-power signal is an LP-WUS or an LP-SS with FSK, the non-low-power signal is associated with a PDSCH transmission, and a frequency allocation associated with PDSCH locations is signaled to a UE associated with a non-low-power receiver.

In an eighth aspect, alone or in combination with one or more of the first through seventh aspects, the low-power signal is an LP-WUS or an LP-SS with OOK, and the non-low-power signal is associated with a PDSCH transmission, and the PDSCH transmission is transmitted based at least in part on an ON duration associated with the low-power signal.

In a ninth aspect, alone or in combination with one or more of the first through eighth aspects, the low-power signal is an OOK signal, the OOK signal is associated with guaranteed portions for an ON duration and an OFF duration, and the guaranteed portions include a 50% portion for the ON duration and a 50% portion for the OFF duration.

In a tenth aspect, alone or in combination with one or more of the first through ninth aspects, the low-power signal is an LP-WUS including a wakeup indication to a group of UEs, and the non-low-power signal includes wakeup information for each UE, or each subgroup of UEs, in the group of UEs.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 7-13. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The communication manager 1606 may generate a multiplexed signal based at least in part on a non-orthogonal multiplexing of a low-power signal and a non-low-power signal, wherein information associated with the non-low-power signal is embedded in a sequence used to modulate the low-power signal. The transmission component 1604 may transmit the multiplexed signal.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a UE, or a UE may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 140 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 7-13. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The reception component 1702 may receive one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a network node, comprising: generating a multiplexed signal based at least in part on a non-orthogonal multiplexing of a low-power signal and a non-low-power signal, wherein information associated with the non-low-power signal is embedded in a sequence used to modulate the low-power signal; and transmitting the multiplexed signal.

Aspect 2: The method of Aspect 1, wherein: the low-power signal is an on-off keying (OOK) signal or a frequency-shift keying (FSK) signal; and the non-low-power signal is an orthogonal frequency division multiplexing (OFDM) signal.

Aspect 3: The method of any of Aspects 1-2, wherein: the low-power signal is directed to a user equipment (UE) associated with a low-power receiver; or the low-power signal and the non-low-power signal are directed to a UE associated with a non-low-power receiver.

Aspect 4: The method of any of Aspects 1-3, wherein the low-power signal is associated with one bit and the non-low-power signal is associated with a plurality of bits, and the low-power signal is directed to a first user equipment (UE) associated with a low-power receiver and the non-low-power signal is directed to a second UE associated with a non-low-power receiver.

Aspect 5: The method of any of Aspects 1-4, wherein: the low-power signal is directed to a first user equipment (UE) and the non-low-power signal is directed to a second UE; or the low-power signal and the non-low-power signal are directed to the first UE.

Aspect 6: The method of any of Aspects 1-5, wherein the low-power signal is a low-power synchronization signal (LP-SS) and the non-low-power signal is associated with system information, and the system information includes one of: a master information block (MIB), a system information block (SIB), or a physical broadcast channel (PBCH).

Aspect 7: The method of any of Aspects 1-6, wherein the low-power signal is a low-power wakeup signal (LP-WUS) or a low-power synchronization signal (LP-SS) with frequency-shift keying (FSK), and the non-low-power signal is associated with a physical downlink control channel (PDCCH) transmission, and FSK information is conveyed in the low-power signal by placing a PDCCH candidate in a frequency region associated with an FSK modulation.

Aspect 8: The method of any of Aspects 1-7, wherein the low-power signal is a low-power wakeup signal (LP-WUS) or a low-power synchronization signal (LP-SS) with frequency-shift keying (FSK), the non-low-power signal is associated with a physical downlink shared channel (PDSCH) transmission, and a frequency allocation associated with PDSCH locations is signaled to a user equipment (UE) associated with a non-low-power receiver.

Aspect 9: The method of any of Aspects 1-8, wherein the low-power signal is a low-power wakeup signal (LP-WUS) or a low-power synchronization signal (LP-SS) with on-off keying (OOK), and the non-low-power signal is associated with a physical downlink shared channel (PDSCH) transmission, and the PDSCH transmission is transmitted based at least in part on an ON duration associated with the low-power signal.

Aspect 10: The method of any of Aspects 1-9, wherein the low-power signal is an on-off keying (OOK) signal, the OOK signal is associated with guaranteed portions for an ON duration and an OFF duration, and the guaranteed portions include a 50% portion for the ON duration and a 50% portion for the OFF duration.

Aspect 11: The method of any of Aspects 1-10, wherein the low-power signal is a low-power wakeup signal (LP-WUS) including a wakeup indication to a group of user equipments (UEs), and the non-low-power signal includes wakeup information for each UE, or each subgroup of UEs, in the group of UEs.

Aspect 12: A method of wireless communication performed by a user equipment (UE), comprising: receiving one or more of a low-power signal or a non-low-power signal, wherein the low-power signal and the non-low-power signal are multiplexed using a non-orthogonal multiplexing to form a multiplexed signal, and information associated with the non-low-power signal is embedded in a sequence used to modulate the low-power signal.

Aspect 13: The method of Aspect 12, wherein: the low-power signal is an on-off keying (OOK) signal or a frequency-shift keying (FSK) signal; and the non-low-power signal is an orthogonal frequency division multiplexing (OFDM) signal.

Aspect 14: The method of any of Aspects 12-13, wherein: the UE is associated with a low-power receiver, and the low-power signal is detectable by the UE; or the UE is associated with a non-low-power receiver, and the low-power signal and the non-low-power signal are detectable by the UE.

Aspect 15: The method of any of Aspects 12-14, wherein the UE is a first UE, the low-power signal is associated with one bit and the non-low-power signal is associated with a plurality of bits, and the low-power signal is directed to the first UE associated with a low-power receiver and the non-low-power signal is directed to a second UE associated with a non-low-power receiver.

Aspect 16: The method of any of Aspects 12-15, wherein the UE is a first UE, and: the low-power signal is directed to the first UE and the non-low-power signal is directed to a second UE; or the low-power signal and the non-low-power signal are directed to the first UE.

Aspect 17: The method of any of Aspects 12-16, wherein the low-power signal is a low-power synchronization signal (LP-SS) and the non-low-power signal is associated with system information, and the system information includes one of: a master information block (MIB), a system information block (SIB), or a physical broadcast channel (PBCH).

Aspect 18: The method of any of Aspects 12-17, wherein the low-power signal is a low-power wakeup signal (LP-WUS) or a low-power synchronization signal (LP-SS) with frequency-shift keying (FSK), and the non-low-power signal is associated with a physical downlink control channel (PDCCH) transmission, and FSK information is conveyed in the low-power signal by placing a PDCCH candidate in a frequency region associated with an FSK modulation.

Aspect 19: The method of any of Aspects 12-18, wherein the low-power signal is a low-power wakeup signal (LP-WUS) or a low-power synchronization signal (LP-SS) with frequency-shift keying (FSK), the non-low-power signal is associated with a physical downlink shared channel (PDSCH) transmission, and a frequency allocation associated with PDSCH locations is signaled to the UE based at least in part on the UE being associated with a non-low-power receiver.

Aspect 20: The method of any of Aspects 12-19, wherein the low-power signal is a low-power wakeup signal (LP-WUS) or a low-power synchronization signal (LP-SS) with on-off keying (OOK), and the non-low-power signal is associated with a physical downlink shared channel (PDSCH) transmission, and the PDSCH transmission is transmitted based at least in part on an ON duration associated with the low-power signal.

Aspect 21: The method of any of Aspects 12-20, wherein the low-power signal is an on-off keying (OOK) signal, the OOK signal is associated with guaranteed portions for an ON duration and an OFF duration, and the guaranteed portions include a 50% portion for the ON duration and a 50% portion for the OFF duration.

Aspect 22: The method of any of Aspects 12-21, wherein the low-power signal is a low-power wakeup signal (LP-WUS) including a wakeup indication to a group of UEs, and the non-low-power signal includes wakeup information for each UE, or each subgroup of UEs, in the group of UEs.

Aspect 23: An apparatus for wireless communication at a device, comprising a processor; memory coupled with the processor; and instructions stored in the memory and executable by the processor to cause the apparatus to perform the method of one or more of Aspects 1-11.

Aspect 24: A device for wireless communication, comprising a memory and one or more processors coupled to the memory, the one or more processors configured to perform the method of one or more of Aspects 1-11.

Aspect 25: An apparatus for wireless communication, comprising at least one means for performing the method of one or more of Aspects 1-11.

Aspect 26: A non-transitory computer-readable medium storing code for wireless communication, the code comprising instructions executable by a processor to perform the method of one or more of Aspects 1-11.

Aspect 27: A non-transitory computer-readable medium storing a set of instructions for wireless communication, the set of instructions comprising one or more instructions that, when executed by one or more processors of a device, cause the device to perform the method of one or more of Aspects 1-11.

Aspect 28: An apparatus for wireless communication at a device, comprising a processor; memory coupled with the processor; and instructions stored in the memory and executable by the processor to cause the apparatus to perform the method of one or more of Aspects 12-22.

Aspect 29: A device for wireless communication, comprising a memory and one or more processors coupled to the memory, the one or more processors configured to perform the method of one or more of Aspects 12-22.

Aspect 30: An apparatus for wireless communication, comprising at least one means for performing the method of one or more of Aspects 12-22.

Aspect 31: A non-transitory computer-readable medium storing code for wireless communication, the code comprising instructions executable by a processor to perform the method of one or more of Aspects 12-22.

Aspect 32: A non-transitory computer-readable medium storing a set of instructions for wireless communication, the set of instructions comprising one or more instructions that, when executed by one or more processors of a device, cause the device to perform the method of one or more of Aspects 12-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a network node, comprising:
one or more memories; and
one or more processors coupled to the one or more memories, the one or more processors individually or collectively configured to:
generate a multiplexed signal based at least in part on a non-orthogonal multiplexing of an on-off keying (OOK) signal and an orthogonal frequency division multiplexing (OFDM) signal, wherein information associated with the OFDM signal is embedded in a sequence used to modulate the OOK signal; and
transmit the multiplexed signal.

2.-4. (canceled)

5. The apparatus of claim 1,
wherein the OOK signal and the OFDM signal are directed to the UE.

6.-9. (canceled)

10. The apparatus of claim 1, the OOK signal is associated with guaranteed portions for an ON duration and an OFF duration, and the guaranteed portions include a 50% portion for the ON duration and a 50% portion for the OFF duration.

11. (canceled)

12. An apparatus for wireless communication at a user equipment (UE), comprising:
one or more memories; and
one or more processors coupled to the one or more memories, the one or more processors individually or collectively configured to:
receive an on-off keying (OOK) signal and an orthogonal frequency division multiplexing (OFDM) signal,
wherein the OOK signal and the OFDM signal are multiplexed using a non-orthogonal multiplexing to form a multiplexed signal, and
wherein information associated with the OFDM signal is embedded in a sequence used to modulate the OOK signal.

13.-15. (canceled)

16. The apparatus of claim 12,
wherein the OOK signal and the signal OFDM are directed to the UE.

17.-20. (canceled)

21. The apparatus of claim 12, wherein the OOK signal is associated with guaranteed portions for an ON duration and an OFF duration, and the guaranteed portions include a 50% portion for the ON duration and a 50% portion for the OFF duration.

22. (canceled)

23. A method of wireless communication performed by a network node, comprising:
generating a multiplexed signal based at least in part on a non-orthogonal multiplexing of an on-off keying (OOK) signal and an orthogonal frequency division multiplexing (OFDM) signal, wherein information associated with the OFDM signal is embedded in a sequence used to modulate the OOK signal; and
transmitting the multiplexed signal.

24.-26. (canceled)

27. The method of claim 23,
wherein the OOK signal and the OFDM signal are directed to the UE.

28.-29. (canceled)

30. A method of wireless communication performed by a user equipment (UE), comprising:
receiving an on-off keying (OOK) signal and an orthogonal frequency division multiplexing (OFDM) signal, wherein the OOK signal and the OFDM signal are multiplexed using a non-orthogonal multiplexing to form a multiplexed signal, and
wherein information associated with the OFDM signal is embedded in a sequence used to modulate the OOK signal.

31. The method of claim 30, wherein the OOK signal and the OFDM signal are directed to the UE.

32. The method of claim 30, wherein the OOK signal is associated with guaranteed portions for an ON duration and an OFF duration, and the guaranteed portions include a 50% portion for the ON duration and a 50% portion for the OFF duration.

33. The method of claim 23, wherein the OOK signal is associated with guaranteed portions for an ON duration and an OFF duration, and the guaranteed portions include a 50% portion for the ON duration and a 50% portion for the OFF duration.
